(19) United States
(12) Patent Application Publication
(10) Pub. No.: US 2019/0223014 A1
(43) Pub. Date: Jul. 18, 2019

(54) SYSTEMS AND METHODS FOR SECURE COMMUNICATION OF ZIGBEE KEYS

(71) Applicant: QUALCOMM Incorporated, San Diego, CA (US)

(72) Inventor: Anand Deshpande, San Jose, CA (US)

(21) Appl. No.: 15/949,359

(22) Filed: Apr. 10, 2018

Related U.S. Application Data
(60) Provisional application No. 62/617,048, filed on Jan. 12, 2018.

(51) Int. Cl. H04W 12/04; H04W 4/80; H04W 8/00; H04W 76/14; H04W 12/06

(52) U.S. Cl. CPC H04W 12/04; H04W 4/80; H04W 12/06; H04W 76/14; H04W 8/005

(57) ABSTRACT

A method by a Zigbee device is described. The method includes advertising that the Zigbee device is present using a second wireless communication technology. The method also includes establishing a wireless link with a mobile device using the second wireless communication technology. The method further includes communicating a Zigbee key with the mobile device using the second wireless communication technology.

### RELATED APPLICATIONS

This application is related to and claims priority from U.S. Provisional Patent Application Ser. No. 62/617,048, filed Jan. 12, 2018, for “SYSTEMS AND METHODS FOR SECURE COMMUNICATION OF ZIGBEE KEYS.”

### TECHNICAL FIELD

The present disclosure relates generally to communications. More specifically, the present disclosure relates to systems and methods for secure communication of Zigbee keys.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform new functions and/or that perform functions faster, more efficiently or more reliably are often sought after.

Some electronic devices communicate with other electronic devices. These electronic devices may transmit and/or receive wireless signals. For example, a wireless communication device may communicate with another wireless communication device using Zigbee communication protocols.

As part of communication in a Zigbee network, Zigbee keys are used to secure communications. However, currently the communication of Zigbee keys is insecure. Therefore, systems and methods for secure communication of Zigbee key may be beneficial.

### SUMMARY

A method by a Zigbee device is described. The method includes advertising that the Zigbee device is present using a second wireless communication technology. The method also includes establishing a wireless link with a mobile device using the second wireless communication technology. The method further includes communicating a Zigbee key with the mobile device using the second wireless communication technology.

Communicating the Zigbee key with the mobile device may include generating, by the Zigbee device, the Zigbee key in response to detecting the mobile device. The Zigbee key may be sent to the mobile device using the second wireless communication technology.

Communicating the Zigbee key with the mobile device may include receiving the Zigbee key from the mobile device using the second wireless communication technology. The mobile device may generate the Zigbee key in response to detecting the Zigbee device.

Advertising that the Zigbee device is present using a second wireless communication technology may include sending an advertising packet, using the second wireless communication technology, that indicates the Zigbee device is available to join a Zigbee network.

The Zigbee device may be a Zigbee Trust Center (TC), Zigbee router (ZR) or Zigbee end-device (ZED). The second wireless communication technology may be Bluetooth Low Energy, WiFi or near-field communication (NFC). The Zigbee key may include a master key or link key used for communication in a Zigbee network.

A Zigbee device is also described. The Zigbee device includes a processor, a memory in electronic communication with the processor and instructions stored in the memory. The instructions are executable by the processor to advertise that the Zigbee device is present using a second wireless communication technology. The instructions are also executable by the processor to establish a wireless link with a mobile device using the second wireless communication technology. The instructions are further executable by the processor to communicate a Zigbee key with the mobile device using the second wireless communication technology.

A method by a mobile device is also described. The method includes detecting that a Zigbee device is present using a second wireless communication technology. The method also includes establishing a wireless link with the Zigbee device using the second wireless communication technology. The method further includes communicating a Zigbee key with the Zigbee device using the second wireless communication technology.

Communicating the Zigbee key with the Zigbee device may include generating, by the mobile device, the Zigbee key in response to detecting the Zigbee device. The Zigbee key may be sent to the Zigbee device using the second wireless communication technology.

Communicating the Zigbee key with the Zigbee device may include receiving the Zigbee key from the Zigbee device using the second wireless communication technology. The Zigbee device may generate the Zigbee key in response to detecting the mobile device.

Detecting that the Zigbee device is present using a second wireless communication technology may include detecting an advertising packet, using the second wireless communication technology, that indicates the Zigbee device is available to join a Zigbee network.

The method may also include saving the Zigbee key in a Zigbee key database. The Zigbee key may be communicated with a second Zigbee device using the second wireless communication technology.

A mobile device is also described. The mobile device includes a processor, a memory in electronic communication with the processor and instructions stored in the memory. The instructions are executable by the processor to detect that a Zigbee device is present using a second wireless communication technology. The instructions are also executable by the processor to establish a wireless link with the Zigbee device using the second wireless communication technology. The instructions are further executable by the processor to communicate a Zigbee key with the Zigbee device using the second wireless communication technology.

### BRIEF DESCRIPTION OF THE DRAWINGS

FIG. 1 is a block diagram illustrating a wireless communication system in which secure communication of Zigbee keys may be implemented;

FIG. 2 is a flow diagram illustrating a method for secure communication of Zigbee keys by a Zigbee device;

FIG. 3 is a flow diagram illustrating a method for secure communication of Zigbee keys by a mobile device;

FIG. 4 is a sequence diagram illustrating current Zigbee security bootstrapping in a high-security mode;

FIG. 5 is a sequence diagram illustrating secure communication of Zigbee keys for a Zigbee trust center (TC);

FIG. 6 is a sequence diagram illustrating secure communication of Zigbee keys for a Zigbee router (ZR);

FIG. 7 is a sequence diagram illustrating another configuration of secure communication of Zigbee keys for a ZR;

FIG. 8 is a sequence diagram illustrating secure communication of Zigbee keys for a Zigbee end-device (ZED);

FIG. 9 is a sequence diagram illustrating another configuration of secure communication of Zigbee keys for a ZED;

FIG. 10 is a block diagram illustrating a secure communication of Zigbee keys in a Zigbee network; and

FIG. 11 illustrates certain components that may be included within a wireless communication device.

### DETAILED DESCRIPTION

Various configurations are described with reference to the Figures, where like reference numbers may indicate functionally similar elements. The systems and methods as generally described and illustrated in the Figures could be arranged and designed in a wide variety of different configurations. Thus, the following more detailed description of several configurations, as represented in the Figures, is not intended to limit scope, but is merely representative.

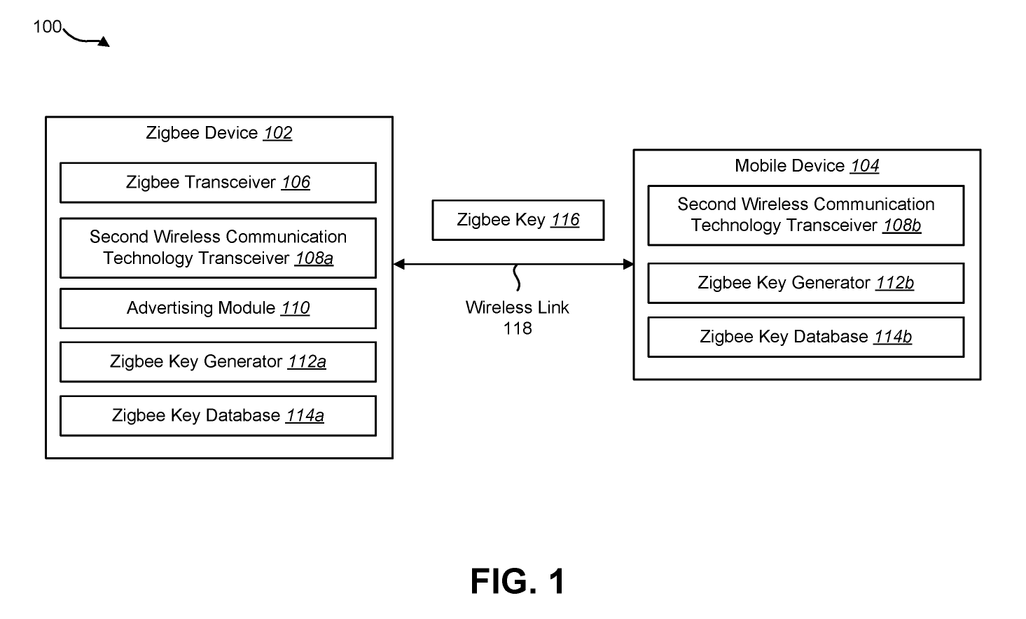

FIG. 1 is a block diagram illustrating a wireless communication system 100 in which secure communication of Zigbee keys 116 may be implemented. Wireless communication systems 100 are widely deployed to provide various types of communication content such as voice, data and so on. The wireless communication system 100 may include a plurality of wireless communication devices. For example, the wireless communication system 100 may include one or more Zigbee devices 102 that are configured to communicate with each other. The one or more Zigbee devices 102 may also be configured to communication with a mobile device 104.

Communications in the wireless communication system 100 may be achieved through transmissions over a wireless link 118. Such a wireless link 118 may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. In some configurations, the wireless communication system 100 may utilize MIMO. A MIMO system may support time division duplex (TDD) and/or frequency division duplex (FDD) systems.

In some configurations, the wireless communication system 100 may operate in accordance with one or more standards. Examples of these standards include Bluetooth (e.g., Institute of Electrical and Electronics Engineers (IEEE) 802.15.1), Bluetooth low energy (BLE), IEEE 802.11 (Wi-Fi), IEEE 802.15.4 (Zigbee), IEEE 802.16 (Worldwide Interoperability for Microwave Access (WiMAX), Global System for Mobile Communications (GSM), Universal Mobile Telecommunications System (UMTS), CDMA2000, Long Term Evolution (LTE), etc. Accordingly, a wireless communication device may communicate with a remote device using a communication protocol such as Zigbee and/or BLE in some configurations.

In some configurations, the wireless communication system 100 may be a multiple-access system capable of supporting communication with multiple wireless communication devices by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, evolution-data optimized (EV-DO) systems, single-carrier frequency division multiple access (SC-FDMA) systems, General Packet Radio Service (GPRS) access network systems, 3rd Generation Partnership Project (3GPP) Long Term Evolution (LTE) systems, and spatial division multiple access (SDMA) systems.

A wireless communication device may be a mobile device 104 and/or a Zigbee device 102. In LTE and UMTS, a wireless communication device may be referred to as a “user equipment” (UE). In 3GPP Global System for Mobile Communications (GSM), a wireless communication device may be referred to as a “mobile station” (MS). A wireless communication device may be referred to as and/or may include some or all of the functionality of a UE, MS, terminal, an access terminal, a subscriber unit, a station, etc. Examples of the wireless communication device include cellular phones, smartphones, wireless headsets, wireless speakers, personal digital assistants (PDAs), wireless devices, electronic automobile consoles, gaming systems, wireless controllers, sensors, wireless modems, handheld devices, laptop computers, Session Initiation Protocol (SIP) phones, wireless local loop (WLL) stations, wearable devices, smart watches, etc.

The systems and methods described herein may be implemented on a variety of different electronic devices. Examples of electronic devices include general purpose or special purpose computing system environments or configurations, personal computers (PCs), server computers, handheld or laptop devices, multiprocessor systems, microprocessor-based systems, programmable consumer electronics, network PCs, minicomputers, mainframe computers, routers, trust centers, servers, distributed computing environments that include any of the above systems or devices and the like. The systems and methods may also be implemented in mobile devices 104 such as phones, smartphones, wireless headsets, personal digital assistants (PDAs), ultra-mobile personal computers (UMPCs), mobile Internet devices (MIDs), etc. Further, the systems and methods may be implemented by battery-operated devices, sensors, etc. The following description refers to Zigbee devices 102 and/or mobile devices 104 for clarity and to facilitate explanation. Those of ordinary skill in the art will understand that a wireless communication device may comprise any of the devices described above as well as a multitude of other devices.

As used herein, a Zigbee device 102 is a wireless communication device that is configured to communicate using Zigbee communication technology and at least a second wireless communication technology. It should be noted that the Zigbee device 102 may be configured to communicate using more than two wireless communication technologies. In an implementation, the second wireless communication technology may be Bluetooth low energy (BLE). However, the second wireless communication technology may also be implemented according to other communication protocols (e.g., WiFi, near-field communication (NFC), etc.).

The Zigbee device 102 may include a Zigbee transceiver 106. In some implementations, the Zigbee transceiver 106 may include a transmitter and/or a receiver.

The Zigbee device 102 may also include a second wireless communication technology transceiver 108a. For example, the Zigbee device 102 may include a BLE transceiver, a WiFi transceiver and/or an NFC transceiver. In some implementations, the second wireless communication technology transceiver 108a may include a transmitter and/or a receiver.

The Bluetooth (BT) wireless communication standard is typically employed for exchanging communications between fixed or mobile Bluetooth-enabled devices over short distances. In some configurations, the systems and methods disclosed herein may be applied to establishing connections between Bluetooth-enabled devices configured to operate according to Bluetooth low energy (BLE) standards.

LE refers to the “Low Energy” extension of the Bluetooth standard. The BLE extension is focused on energy-constrained applications such as battery-operated devices, sensor applications, etc. The following description uses terminology associated with the Bluetooth and Bluetooth LE standards. Nevertheless, the concepts may be applicable to other technologies and standards that involve modulating and transmitting digital data. Accordingly, while some of the description is provided in terms of Bluetooth standards, the systems and methods disclosed herein may be implemented more generally in wireless communication devices 102 that may not conform to Bluetooth standards.

BLE systems operate in the unlicensed 2.4 gigahertz (GHz) Industrial-Scientific-Medical (ISM) band at 2.400-2.4835 GHz (2400-2483.5 megahertz (MHz)). As part of the device discovery and connection setup procedure, the Zigbee device 102 may transmit advertisement packets on BLE advertising channels. A remote device (e.g., the mobile device 104) may perform periodic scans on the advertising channels to detect these advertisement packets.

In one implementation, the Zigbee device 102 may communicate using BLE v4.2 secure link. BLE v4.2 provides a “public-private” key pair for securing a BLE link. In other implementations, the Zigbee device 102 may communicate using other versions of Bluetooth (e.g., BLE 4.0/4.1).

The Zigbee standard operates on the IEEE 802.15.4 physical radio specification and operates in unlicensed bands including 2.4 GHz, 900 MHz and 868 MHz. The Zigbee protocol may be used to create personal area networks (PANs). Zigbee technology is particularly well-suited for small, low-power devices. Examples of Zigbee applications include home automation, medical device data collection, sensors and other low-power low-bandwidth needs.

In a Zigbee network, Zigbee devices 102 may have different roles. These roles include a Zigbee Coordinator (ZC) (which is also referred to as a trust center (TC)), a Zigbee router (ZR) and a Zigbee end-device (ZED) (which is also referred to as a joiner). Typically, the TC is responsible for key distribution and network join policy. Therefore, the Zigbee device 102 may have (e.g., may be configured to operate in) any one of these roles on a Zigbee network.

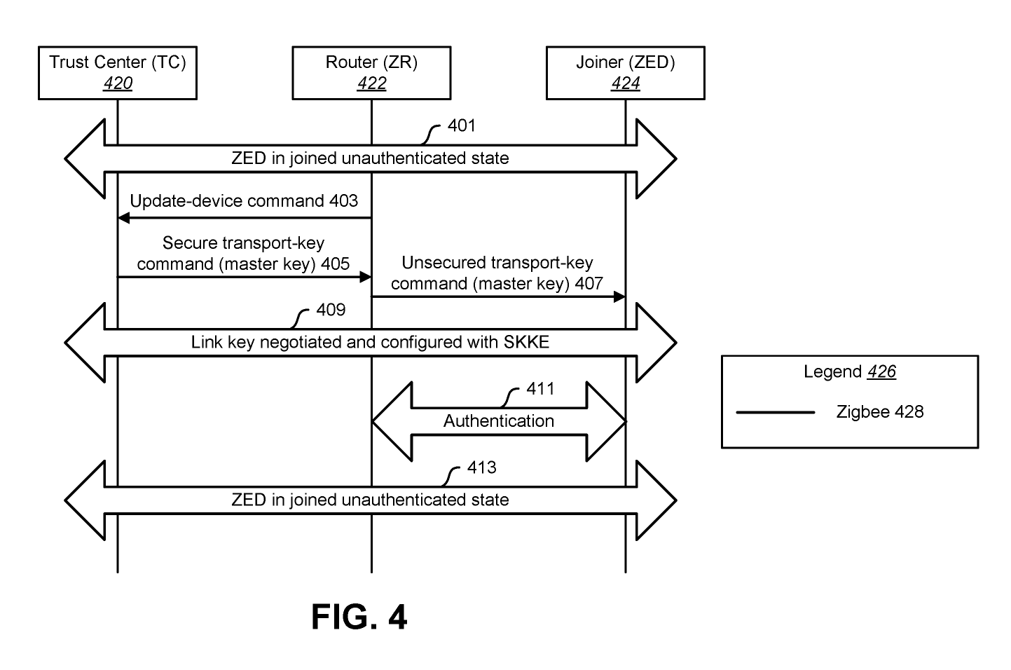

Zigbee network security is established in three distinct steps. In a first step (Step 1), the TC is configured with a set of master keys. Currently, the master keys are preconfigured out-of-band. This out-of-band mechanism is potentially at manufacturing time. In a second step (Step 2), when a new device (e.g., router (ZR) or end-device (ZED)) joins a TC, a link key is negotiated. Alternately, a new device is pre-loaded with the trust center address and an initial master key. In a third step (Step 3), with a mutually known link key, the TC passes a “network key” to the new device, which is used for all traffic among the network. An example of current Zigbee Security Bootstrapping in high-security mode is depicted in FIG. 4.

Currently, all Zigbee-enabled products in the world use a known master key. This master key is given to a Zigbee integrated circuit (IC) manufacturer under a non-disclosure agreement (NDA). However, this method of securing network connections is inherently insecure. Because master keys are programmed at manufacturing time, they are vulnerable to eavesdropping and also they are sent un-encrypted to a ZR and/or ZED. Pre-loading of a TC master key for the ZR and/or ZED is also vulnerable.

The systems and methods described herein avoid the problems associated with using preconfigured keys for establishing communications in a Zigbee network. An application (also referred to as an app or program) on a mobile device 104 may be used to facilitate the distribution of Zigbee keys 116 within a Zigbee network. When the mobile device application communicates with Zigbee-enabled chipsets, a much more secure Zigbee key 116 (e.g., master key and/or link key) may be programmed at run time. The systems and methods described herein avoid the need to manually program and pass a master key and pre-load a ZR/ZED with the TC master keys.

Zigbee devices 102 (e.g., TC, ZR and ZED) may include Zigbee functionality and a second (non-Zigbee) wireless communication technology (e.g., Bluetooth, WiFi, near-field communication (NFC), etc.). In one implementation, an application running on a mobile device 104 may use a Bluetooth Low Energy (BLE) link to configure one or more Zigbee devices 102 (e.g., TC, ZR and/or ZED). This makes it very easy for a user to use a mobile device application to quickly onboard a Zigbee network. For example, 60-70% of phones in the world today are enabled with BLE v.4.2 technology. However, few mobile phones are configured with Zigbee.

As used herein, the term “onboard” or “onboarding” refers to a process of adding a device (e.g., Zigbee device 102) to a network (e.g., Zigbee network). For example, a Zigbee device 102 may be onboarded in a Zigbee network by performing one or more of the following steps: exchanging Zigbee Keys 116 and authenticating the Zigbee device 102 using the Zigbee Keys 116.

BLE (e.g., BLE v4.2 secure link or BLE v4.0/4.1) may be used to onboard another wireless communication technology such as Zigbee. For example, BLE v4.2 provides a “public-private” key pair for securing a BLE link. When a wireless communication device has Zigbee and BLE, the wireless communication device may connect to a Zigbee network for the first time using a BLE secure link by passing Zigbee keys 116 and/or other credentials (e.g., SSID, password, security type) from another mobile device 104.

It should be noted that although BLE v4.0/4.1 may be less secure than BLE v4.2, measures may be taken to secure BLE v4.0/4.1. For example a low transmit power may be used to ensure that network communication has a very short range, which is resistant to eavesdropping.

The Zigbee device 102 may advertise its presence using a second wireless communication technology. For example, the Zigbee device 102 may include an advertising module 110. The advertising module 110 may cause the Zigbee device 102 to broadcast advertising packets when the Zigbee device 102 turns on or joins a Zigbee network in an unauthenticated state. In an implementation, the Zigbee device 102 may broadcast BLE advertising packets. The advertising packets may indicate that the Zigbee device 102 is attempting to join a Zigbee network. For example, a BLE advertising packet may include information (e.g., in a packet protocol data unit (PDU) or payload) that identifies the Zigbee device 102 as seeking to join a Zigbee network. The advertising packet may also indicate that the Zigbee device 102 requires one or more Zigbee keys 116 to join the Zigbee network.

The mobile device 104 may detect the advertising packets sent by the Zigbee device 102 using the second wireless communication technology. For example, the mobile device application running on the mobile device 104 may periodically cause the mobile device 104 to scan for BLE advertising packets that indicate that a Zigbee device 102 is attempting to join a Zigbee network and requires one or more Zigbee keys 116. The mobile device 104 may then establish a wireless link 118 with the Zigbee device 102 using the second wireless communication technology. For example, the mobile device 104 and the Zigbee device 102 may establish a BLE link. In some implementations, the wireless link 118 may be a peer-to-peer link between the Zigbee device 102 and the mobile device 104, which may avoid problems associated with broadcast communications.

The mobile device 104 and the Zigbee device 102 may communicate a Zigbee key 116 using the second wireless communication technology. The Zigbee key 116 may be a Zigbee master key or Zigbee link key used for communication in a Zigbee network.

In one implementation, the mobile device 104 may generate a random Zigbee key 116 in response to detecting the presence of the Zigbee device 102. For example, the mobile device 104 may include a Zigbee key generator 112b that generates one or more random Zigbee keys 116 (e.g., a Zigbee master key and/or Zigbee link key). In this case, the mobile device 104 may transmit the Zigbee key 116 to the Zigbee device 102 using the second wireless communication technology. For example, the mobile device 104 may use a BLE link to transmit the Zigbee key 116.

In another implementation, the Zigbee device 102 may generate the random Zigbee key 116 in response to detecting the presence of the mobile device 104. For example, the Zigbee device 102 may include a Zigbee key generator 112a that generates one or more random Zigbee keys 116 (e.g., a Zigbee master key and/or Zigbee link key). In this case, the Zigbee device 102 may transmit the Zigbee key 116 to the mobile device 104 using the second wireless communication technology. For example, the Zigbee device 102 may use a BLE link to transmit the Zigbee key 116.

In one approach to set up a Zigbee device 102 acting as a TC, a Zigbee device 102 may be configured with Zigbee and BLE communication technologies. In other words, the Zigbee device 102 may include a Zigbee transceiver 106 and a BLE transceiver. This Zigbee device 102 may also (optionally) include WiFi communication technologies. This Zigbee device 102 may act as the TC.

Upon powering up, the TC may advertise its presence using BLE (or other non-Zigbee wireless communication technology). A mobile device 104 may be configured with a second wireless communication technology transceiver 108b. For example, the mobile device 104 may include a BLE transceiver. The mobile device 104 may detect the TC and establish a wireless link 118 (e.g., BLE v4.0, v4.1 or v4.2, etc.) with the Zigbee device 102. In an implementation, a BLE link may be established after WiFi is onboarded through BLE.

The mobile device 104 may communicate a sufficiently random master key with the TC. In one approach, an application or program (referred to herein as a mobile app) of the mobile device 104 may generate the Zigbee master key. For example, the mobile device 104 may include a Zigbee key generator 112b that generates a random Zigbee master key. The mobile device 104 may save the Zigbee key 116 in a Zigbee key database 114b. The mobile device 104 may send the Zigbee key 116 to the Zigbee device 102 using the second wireless communication technology transceiver 108b. The Zigbee device 102 may store this Zigbee master key in its Zigbee key database 114a for later use. For example, the mobile device 104 may communicate (e.g., send) the Zigbee key 116 to a second Zigbee device 102 using the second wireless communication technology.

In another approach the Zigbee device 102 acting as a TC generates the master key. The Zigbee device 102 may include a Zigbee key generator 112a that generates the Zigbee master key. The Zigbee device 102 may store the Zigbee key 116 in a Zigbee key database 114a. The Zigbee device 102 may send the Zigbee key 116 to the mobile device 104 using the second wireless communication technology transceiver 108a. The mobile device 104 may store this Zigbee master key in its Zigbee key database 114b for later use to onboard other Zigbee devices 102. It should be noted that wireless technologies other than BLE may be used to communicate the Zigbee master key. For example, the mobile device 104 may use WiFi, NFC or other non-Zigbee technologies to communicate the Zigbee master key with the Zigbee device 102.

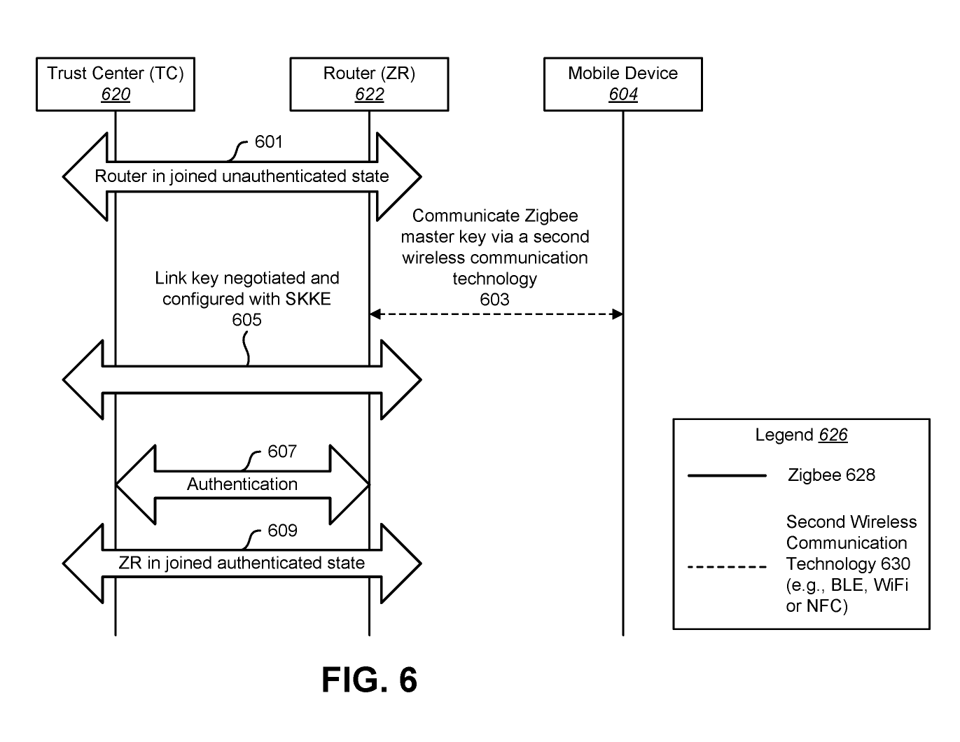

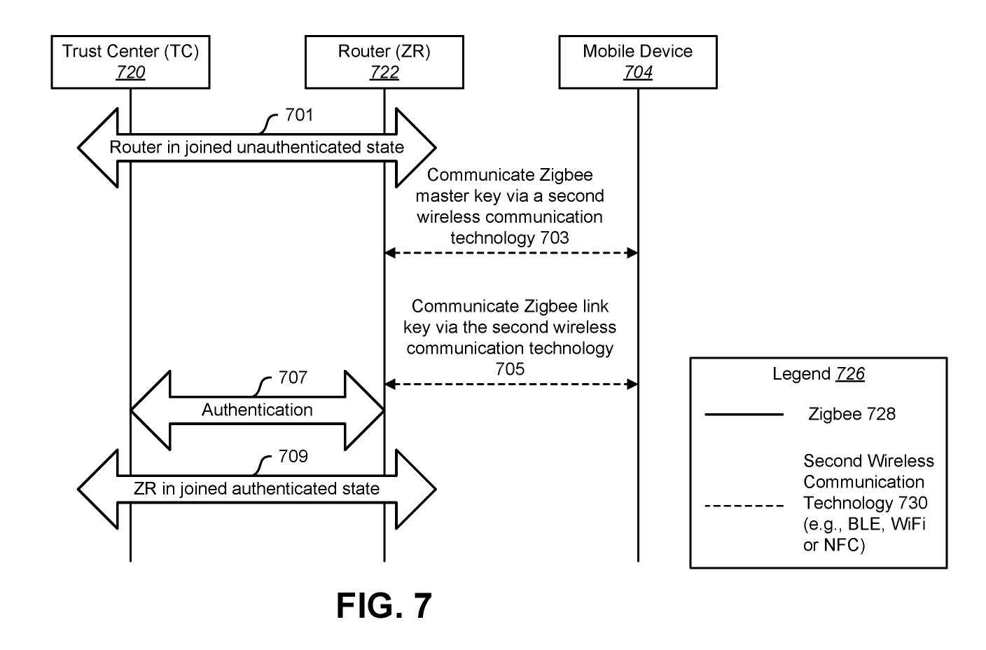

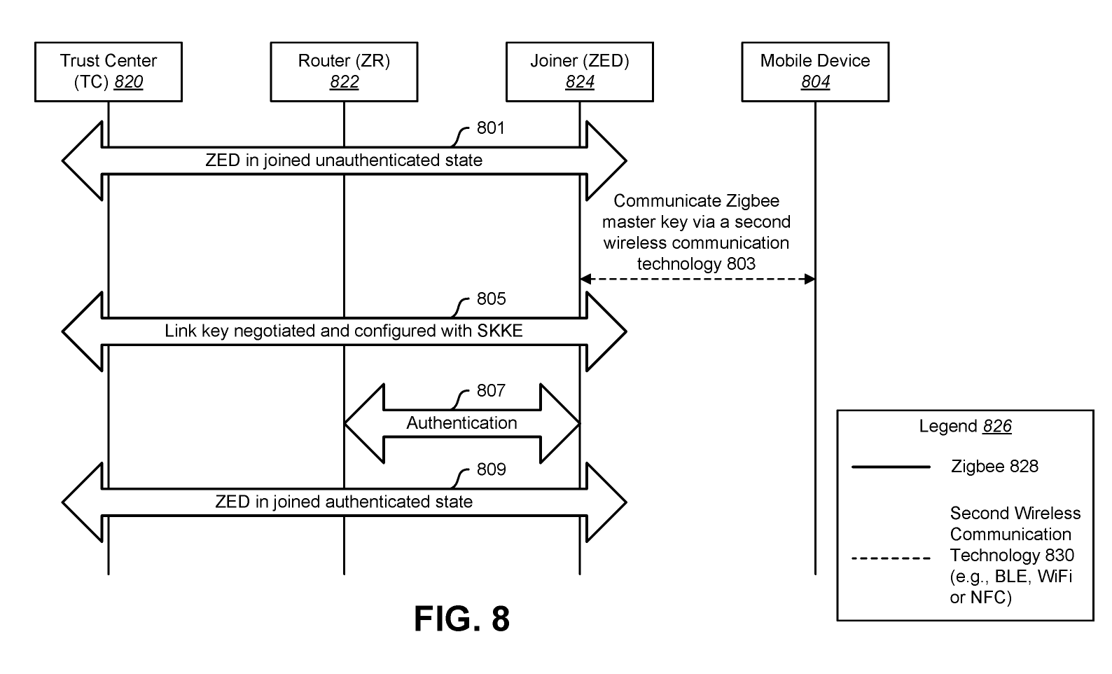

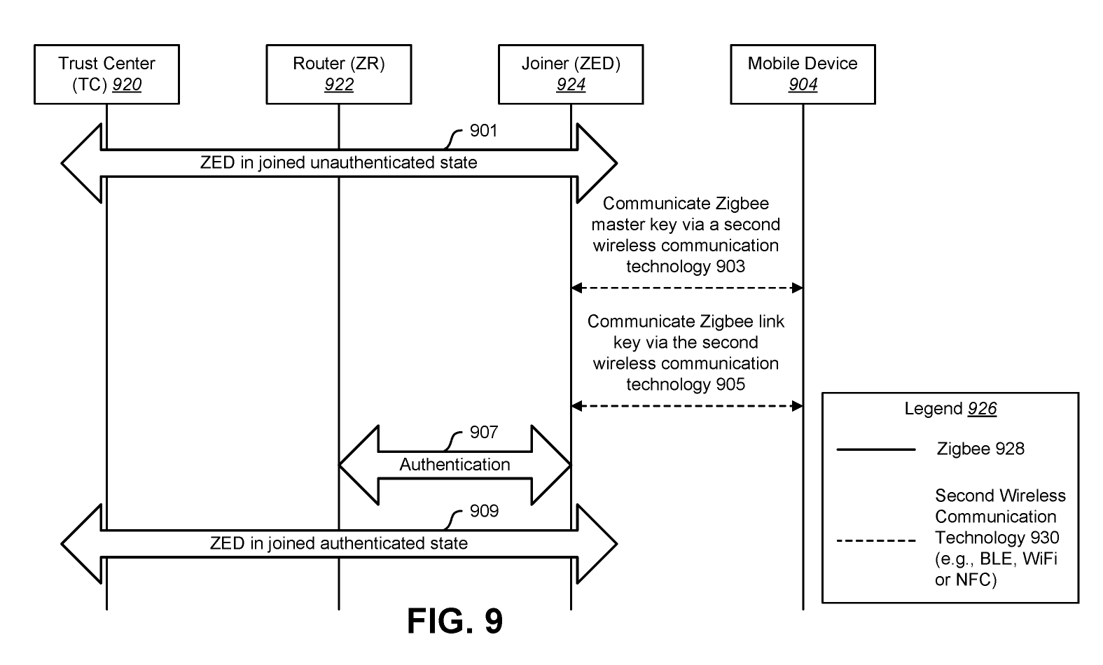

Step 2 described above may be modified as follows. For ZR or ZED setup, a Zigbee device 102 may be configured with Zigbee and a second wireless communication technology (e.g., BLE, WiFi, NFC, etc.). This Zigbee device 102 may act as a ZR or ZED. The product manufacturer may program the non-volatile memory (NVM) of the Zigbee device 102 to determine whether it is line- or battery-powered. A battery-powered device may operate as a ZED by default and a line-powered device may operate as a ZR. FIG. 6 and FIG. 7 show an approach for modified security bootstrapping for a ZR. FIG. 8 shows an approach for modified security bootstrapping for a ZED. FIG. 9 shows an alternative approach for modified security bootstrapping for a ZED.

In the case a Zigbee device 102 acting as a ZR or ZED, the mobile device 104 may communicate the Zigbee master key of the TC to Zigbee device 102 using the second wireless communication technology. For example, the mobile device 104 may store the Zigbee master key in its Zigbee key database 114b as described above. Upon detecting the advertising packets sent by the Zigbee device 102 acting as a ZR or ZED, the mobile device 104 may retrieve Zigbee master key from the Zigbee key database 114b. The mobile device 104 may send the Zigbee master key to the Zigbee device 102 using the second wireless communication technology. The Zigbee device 102 may then join the Zigbee network using this Zigbee master key. For example, the Zigbee device 102 may be authenticated with the TC using this Zigbee master key.

A significant benefit of the systems and methods described herein is that the Zigbee keys 116 (e.g., Zigbee master key and/or link keys) are generated on-the-spot at a user's premises rather than generated at manufacturing time, which makes complete Zigbee network onboarding much more secure. The user is in full control of the onboarding experience. A second significant benefit is it is much easier for a less technology-savvy user to connect new Zigbee-capable devices (e.g., appliances, sensor nodes, etc.) to a network with a few clicks on a mobile app.

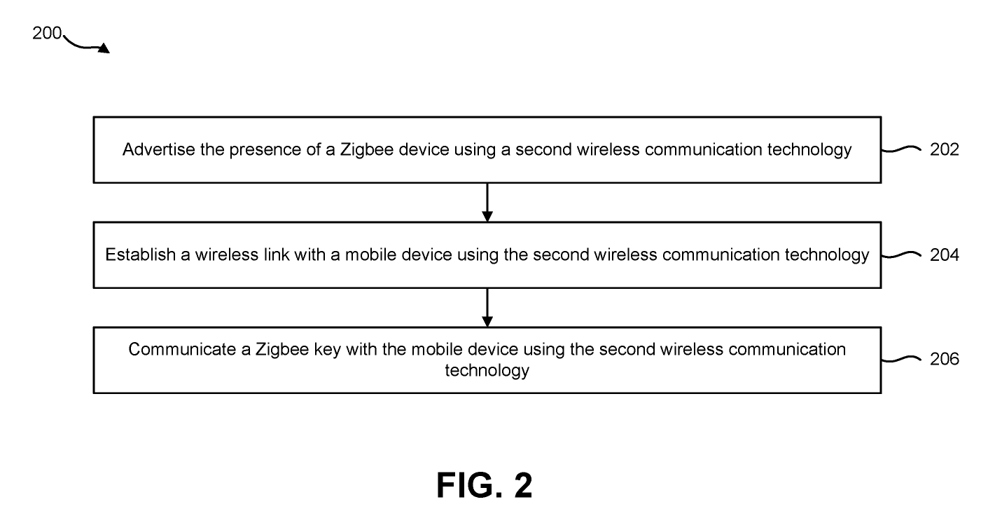

FIG. 2 is a flow diagram illustrating a method 200 for secure communication of Zigbee keys 116 by a Zigbee device 102. The Zigbee device 102 may advertise 202 its presence using a second wireless communication technology. In some implementations, the second wireless communication technology may be Bluetooth Low Energy (BLE), WiFi or NFC. The Zigbee device 102 may be a Zigbee Trust Center (TC), router (ZR) or end-device (ZED). In other words, the Zigbee device 102 may assume (e.g., may be configured to operate in) the role of a TC, ZR or ZED.

In an implementation, the Zigbee device 102 may advertise 202 its presence by transmitting advertising packets using the second wireless communication technology. For example, the Zigbee device 102 may send BLE advertising packets that indicate that the Zigbee device 102 is available to join a Zigbee network.

The Zigbee device 102 may establish 204 a wireless link 118 with a mobile device 104 using the second wireless communication technology. For example, the mobile device 104 may detect the advertisements from the Zigbee device 102 and establish the wireless link 118 with the Zigbee device 102. For example, the Zigbee device 102 and the mobile device 104 may establish 204 a BLE link.

The Zigbee device 102 may communicate 206 a Zigbee key 116 with the mobile device 104 using the second wireless communication technology. The Zigbee key 116 may include a master key or link key (or both) used for communication in a Zigbee network.

In one approach, the Zigbee device 102 may generate the Zigbee key 116 in response to detecting the presence of the mobile device 104. For example, upon establishing the wireless link 118 with the mobile device 104, the Zigbee device 102 may generate the Zigbee key 116. The Zigbee device 102 may then send the Zigbee key 116 to the mobile device 104.

In another approach, the mobile device 104 may generate the Zigbee key 116 in response to detecting the presence of the Zigbee device 102. For example, upon establishing the wireless link 118 with the Zigbee device 102, the mobile device 104 may generate the Zigbee key 116. The mobile device 104 may then send the Zigbee key 116 to the Zigbee device 102.

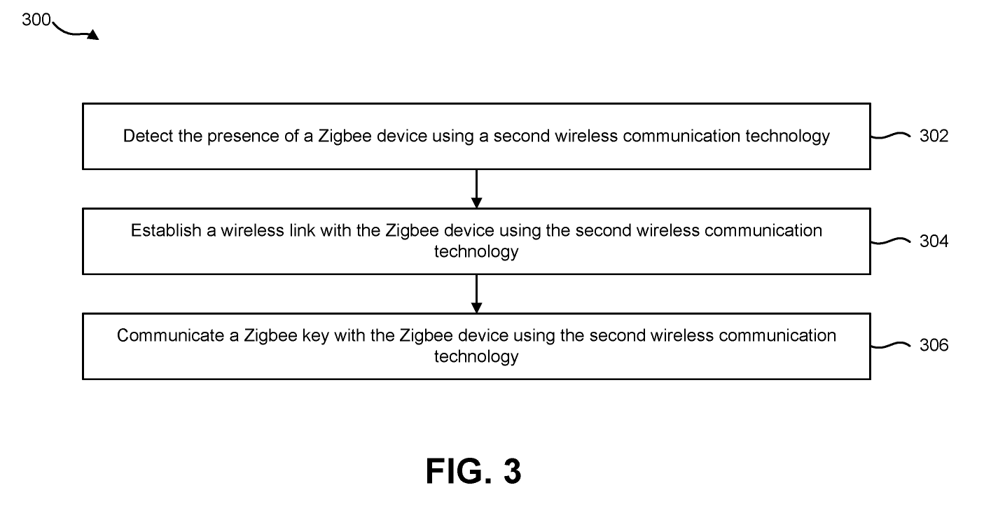

FIG. 3 is a flow diagram illustrating a method 300 for secure communication of Zigbee keys 116 by a mobile device 104. The mobile device 104 may detect 302 the presence of a Zigbee device 102 using a second wireless communication technology. The second wireless communication technology may be Bluetooth Low Energy (BLE), WiFi or NFC. The Zigbee device 102 may be a Zigbee Trust Center (TC), router (ZR) or end-device (ZED).

In an implementation, the Zigbee device 102 may advertise its presence by transmitting advertising packets using the second wireless communication technology. For example, the Zigbee device 102 may send BLE advertising packets that indicate that the Zigbee device 102 is available to join a Zigbee network. The mobile device 104 may detect the advertising packets from the Zigbee device 102 while scanning for advertising packets.

The mobile device 104 may establish 304 a wireless link 118 with the Zigbee device 102 using the second wireless communication technology. For example, the mobile device 104 may establish 304 a BLE link with the Zigbee device 102 upon detecting the BLE advertisements sent by the Zigbee device 102.

The mobile device 104 may communicate 306 a Zigbee key 116 with the mobile device 104 using the second wireless communication technology. The Zigbee key 116 may include a master key or link key (or both) used for communication in a Zigbee network.

In one approach, the Zigbee device 102 may generate the Zigbee key 116 in response to detecting the presence of the mobile device 104. For example, upon establishing the wireless link 118 with the mobile device 104, the Zigbee device 102 may generate the Zigbee key 116. The Zigbee device 102 may then send the Zigbee key 116 to the mobile device 104. The mobile device 104 may save the Zigbee key 116 in a Zigbee key database 114b.

In another approach, the mobile device 104 may generate the Zigbee key 116 in response to detecting the presence of the Zigbee device 102. For example, upon establishing the wireless link 118 with the Zigbee device 102, the mobile device 104 may generate the Zigbee key 116. The mobile device 104 may then send the Zigbee key 116 to the Zigbee device 102. The mobile device 104 may save the Zigbee key 116 in a Zigbee key database 114b.

In some implementations, the mobile device 104 may communicate (e.g., send) the Zigbee key 116 with a second Zigbee device 102 using the second wireless communication technology. For example, after generating the Zigbee key 116 or receiving the Zigbee key 116 from a first Zigbee device 102 (e.g., Zigbee trust center), the mobile device 104 may save the Zigbee key 116. At a later time, the mobile device 104 may send the saved Zigbee key 116 to a second Zigbee device 102 (e.g., Zigbee router or Zigbee end-device) that the mobile device 104 detects. In some implementations, the mobile device 104 may send the saved Zigbee key 116 to a second Zigbee device 102 during an onboarding procedure to add the second Zigbee device 102 to a Zigbee network.

FIG. 4 is a sequence diagram illustrating current Zigbee security bootstrapping in a high-security mode. A Zigbee trust center (TC) 420, router (ZR) 422 and joiner (ZED) 424 may be in a Zigbee network. A legend 426 indicates communications using Zigbee communication protocols 428.

The joiner (ZED) 424 may join 401 the Zigbee network in a joined unauthenticated state.

Upon detecting the joiner (ZED) 424, the router (ZR) 422 may send 403 an update-device command to the trust center (TC) 420. The trust center (TC) 420 may send 405 a secure transport-key command using its master key. It should be noted that in this implementation, the master key of the TC 420 is preconfigured (during manufacturing, for instance). The router (ZR) 422 may then send 407 an unsecured transport-key command to the joiner (ZED) 424 using the master key. It should be noted that this results in an insecure master-key exchange. For example, because the master key used by the trust center (TC) 420 may be preconfigured during manufacturing, this makes this master key vulnerable to being compromised.

The joiner (ZED) 424 may perform 409 link key negotiation with the trust center (TC) 420 via the router (ZR) 422. The link key may be negotiated and configured with a Symmetric-Key Key Exchange (SKKE). The joiner (ZED) 424 may authenticate 411 with the router (ZR) 422 and then join 413 the Zigbee network in an authenticated state.

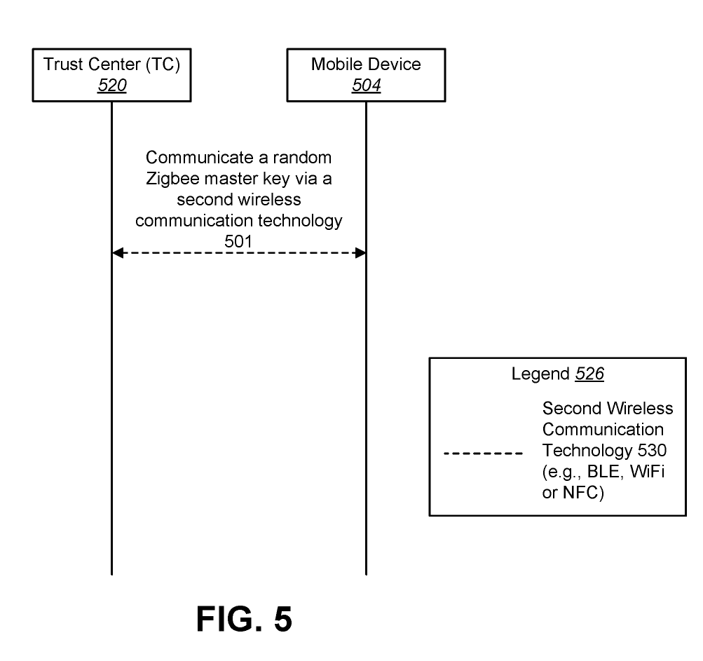

FIG. 5 is a sequence diagram illustrating secure communication of Zigbee keys 116 for a Zigbee trust center (TC) 520. The TC 520 may be configured with Zigbee and a second wireless communication technology (e.g., BLE, WiFi and/or NFC). A legend 526 indicates communications using a second wireless communication technology 530. The TC 520 may be implemented in accordance with the Zigbee device 102 described in connection with FIG. 1. The mobile device 504 may be implemented in accordance with the mobile device 104 described in connection with FIG. 1.

Upon powering up, the TC 520 may advertise its presence using the second wireless communication technology. For example, the TC 520 may advertise (e.g., send advertising packets) using BLE, WiFi and/or NFC. A mobile device 504 may detect the TC 520 and may establish a wireless link 118 with the Zigbee device 102 on the second wireless communication technology.

The mobile device 504 may communicate 501 a sufficiently random Zigbee master key with the TC 520 via the second wireless communication technology. In one approach, the mobile device 504 (e.g., a mobile app of the mobile device 504) generates the Zigbee master key. In another approach the TC 520 generates the master key. The mobile device 504 may store this master key for later use to onboard other Zigbee devices 102. The master key may be communicated (e.g., transmitted and/or received) using the wireless link 118 on the second wireless communication technology.

FIG. 6 is a sequence diagram illustrating secure communication of Zigbee keys 116 for a Zigbee router (ZR) 622. The ZR 622 may be configured with Zigbee and a second wireless communication technology (e.g., BLE, WiFi and/or NFC). A legend 626 indicates communications using Zigbee communication protocols 628 and communications using a second wireless communication technology 630 (e.g., BLE, WiFi, NFC). A TC 620 and the ZR 622 may be implemented in accordance with the Zigbee device 102 described in connection with FIG. 1. A mobile device 604 may be implemented in accordance with the mobile device 104 described in connection with FIG. 1.

The ZR 622 may join 601 a Zigbee network in an unauthenticated state. For example, when the ZR 622 is turned ON for the first time, the ZR 622 may join 601 the Zigbee network in an unauthenticated state.

The ZR 622 may advertise its presence using the second wireless communication technology. For example, the ZR 622 may advertise (e.g., send advertising packets) using BLE, WiFi and/or NFC. The mobile device 604 may detect the ZR 622 and may establish a wireless link 118 with the ZR 622 on the second wireless communication technology.

The mobile device 604 may communicate 603 the Zigbee master key of the TC 620 securely to the ZR 622 using the wireless link 118 on the second wireless communication technology. For example, the mobile device 604 may store the master key of the TC 620 as described in connection with FIG. 5. The mobile device 604 may send the master key to the ZR 622 using the wireless link 118 on the second wireless communication technology.

Using the Zigbee master key received from the mobile device 604 over the wireless link 118 on the second wireless communication technology, the ZR 622 may perform 605 link key negotiation and configuration with the TC using SKKE. The ZR 622 may then authenticate 607 with the TC 620 and join 609 the Zigbee network in an authenticated state.

In FIG. 6, the step of transporting the master key from the TC 620 is avoided completely. It should be noted that according to the systems and methods described herein, the update-device command (step 403) and insecure transport-key command (step 407) as shown in FIG. 4 may be avoided. Instead, the ZR 622 may receive the Zigbee master key of the TC 620 from the mobile device 604 in a secure wireless link 118 on the second wireless communication technology.

FIG. 7 is a sequence diagram illustrating another configuration of secure communication of Zigbee keys 116 for a Zigbee router (ZR) 722. The ZR 722 may be configured with Zigbee and a second wireless communication technology (e.g., BLE, WiFi and/or NFC). A legend 726 indicates communications using Zigbee communication protocols 728 and communications using a second wireless communication technology 730 (e.g., BLE, WiFi, NFC). A TC 720 and the ZR 722 may be implemented in accordance with the Zigbee device 102 described in connection with FIG. 1. A mobile device 704 may be implemented in accordance with the mobile device 104 described in connection with FIG. 1.

The ZR 722 may join 701 a Zigbee network in an unauthenticated state. For example, when the ZR 722 is turned ON for the first time, the ZR 722 may join 701 the Zigbee network in an unauthenticated state.

The ZR 722 may advertise its presence using the second wireless communication technology. For example, the ZR 722 may advertise (e.g., send advertising packets) using BLE, WiFi and/or NFC. The mobile device 704 may detect the ZR 722 and may establish a wireless link 118 with the ZR 722 on the second wireless communication technology.

The mobile device 704 may communicate 703 the master key of the TC 720 securely to the ZR 722 using the wireless link 118 on the second wireless communication technology. For example, the mobile device 704 may store the master key of the TC 720 as described in connection with FIG. 5. The mobile device 704 may send the master key to the ZR 722 using the wireless link 118 on the second wireless communication technology.

In an alternative to link key negotiation shown in FIG. 8, the link key may be directly communicated 705 to the ZR 722 by the mobile device 704. For example, the mobile device 704 may generate a Zigbee link key for the ZR 722 using the stored master key of the TC 720. The mobile device 704 may send the link key to the ZR 722 using the wireless link 118 on the second wireless communication technology. The ZR 722 may then proceed to authentication 707 directly and join 709 the Zigbee network in a joined authenticated state.

In this alternative, the mobile device 704 may generate the link key for the ZR 722. The mobile device 704 may then communicate the link key to the ZR 722 using the wireless link 118 on the second wireless communication technology (e.g., BLE). The mobile device 704 may also communicate the link key generated for the ZR 722 to the TC 720 via a wireless link 118 with the TC 720 on the second wireless communication technology.

In FIG. 7, the step of transporting the master key from the TC 720 to the ZR 722 is avoided completely. Instead, the ZR 722 receives the link key directly. This will prevent the Zigbee master key from being insecurely sent from the TC 720 to the ZR 722.

FIG. 8 is a sequence diagram illustrating secure communication of Zigbee keys 116 for a Zigbee end-device (ZED) 824. The ZED 824 may be configured with Zigbee and BLE communication technologies.

A legend 826 indicates communications using Zigbee communication protocols 828 and communications using a second wireless communication technology 830 (e.g., BLE, WiFi, NFC). A TC 820, a ZR 822 and the ZED 824 may be implemented in accordance with the Zigbee device 102 described in connection with FIG. 1. A mobile device 804 may be implemented in accordance with the mobile device 104 described in connection with FIG. 1.

The ZED 824 may join 801 a Zigbee network in an unauthenticated state. For example, when the ZED 824 is turned ON for the first time, the ZED 824 may join 801 the Zigbee network in an unauthenticated state.

The ZED 824 may advertise its presence using the second wireless communication technology. For example, the ZED 824 may advertise (e.g., send advertising packets) using BLE, WiFi and/or NFC. The mobile device 804 may detect the ZED 824 and may establish a wireless link 118 with the ZED 824 on the second wireless communication technology.

The mobile device 804 may communicate 803 the master key of the TC 820 securely to the ZED 824 using the wireless link 118 on the second wireless communication technology (e.g., BLE connection). For example, the mobile device 804 may store the master key of the TC 820 as described in connection with FIG. 5. The mobile device 804 may send the stored master key to the ZED 824.

Using the Zigbee master key received from the mobile device 804 over the second wireless communication technology, the ZED 824 may perform 805 link key negotiation and configuration with the TC 820 using SKKE. The ZED 824 may then authenticate 807 with the ZR 822 and join 809 the Zigbee network in an authenticated state.

In FIG. 8, the step of transporting the master key from the TC 820 to the ZED 824 and/or ZR 822 is avoided completely. Instead, the ZED 824 goes to the link key negotiation phase directly. This will prevent the master key from being insecurely sent to a ZR 822 and/or ZED 824. The link key negotiation phase will be automatically executed securely as the link key is generated securely from the master key. For example, the mobile device 804 may store the master key of the TC 820 as described in connection with FIG. 5. The mobile device 804 may then send the master key to the ZED 824 using a secure BLE link.

FIG. 9 is a sequence diagram illustrating another configuration of secure communication of Zigbee keys 116 for a Zigbee end-device (ZED) 924. The ZED may be configured with Zigbee and a second wireless communication technology (e.g., BLE, WiFi and/or NFC).

A legend 926 indicates communications using Zigbee communication protocols 928 and communications using a second wireless communication technology 930 (e.g., BLE, WiFi, NFC). A TC 920, a ZR 922 and the ZED 924 may be implemented in accordance with the Zigbee device 102 described in connection with FIG. 1. A mobile device 904 may be implemented in accordance with the mobile device 104 described in connection with FIG. 1.

The ZED 924 may join 901 a Zigbee network in an unauthenticated state. For example, when the ZED 924 is turned ON for the first time, the ZED 924 may join 901 the Zigbee network in an unauthenticated state.

The ZED 924 may advertise its presence using the second wireless communication technology. For example, the ZED 924 may advertise (e.g., send advertising packets) using BLE, WiFi and/or NFC. The mobile device 904 may detect the ZED 924 and may establish a wireless link 118 with the ZED 924 on the second wireless communication technology.

The mobile device 904 may communicate 903 the master key of the TC 920 securely to the ZED 924 using the wireless link 118 on the second wireless communication technology. For example, the mobile device 904 may store the master key of the TC 920 as described in connection with FIG. 5. The mobile device 904 may send the master key to the ZED 924 using the wireless link 118 on the second wireless communication technology.

In an alternative to link key negotiation shown in FIG. 8, the link key may be directly communicated 905 to the ZED 924 by the mobile device 904. For example, the mobile device 904 may generate a Zigbee link key for the ZED 924 using the stored master key of the TC 920. The mobile device 904 may send the link key to the ZED 924 using the wireless link 118 on the second wireless communication technology. The ZED 924 may then proceed to authentication 907 directly and join 909 the Zigbee network in a joined authenticated state.

In this alternative, the mobile device 904 may generate the link key for the ZED 924 or ZR 922. The mobile device 904 may then communicate the link key to the ZED 924 via the wireless link 118 on the second wireless communication technology (e.g., BLE). The mobile device 904 may also communicate the link key generated for the ZED 924 to the TC 920 via a wireless link 118 with the TC 920 on the second wireless communication technology.

In FIG. 9, the step of transporting the master key from the TC 920 to the ZED 924 and/or ZR 922 is avoided completely. Instead, the ZED 924 receives the link key directly from the mobile device 904 using a secure connection on the second wireless communication technology. This will prevent the master key from being insecurely sent to a ZED 924 and/or ZR 922.

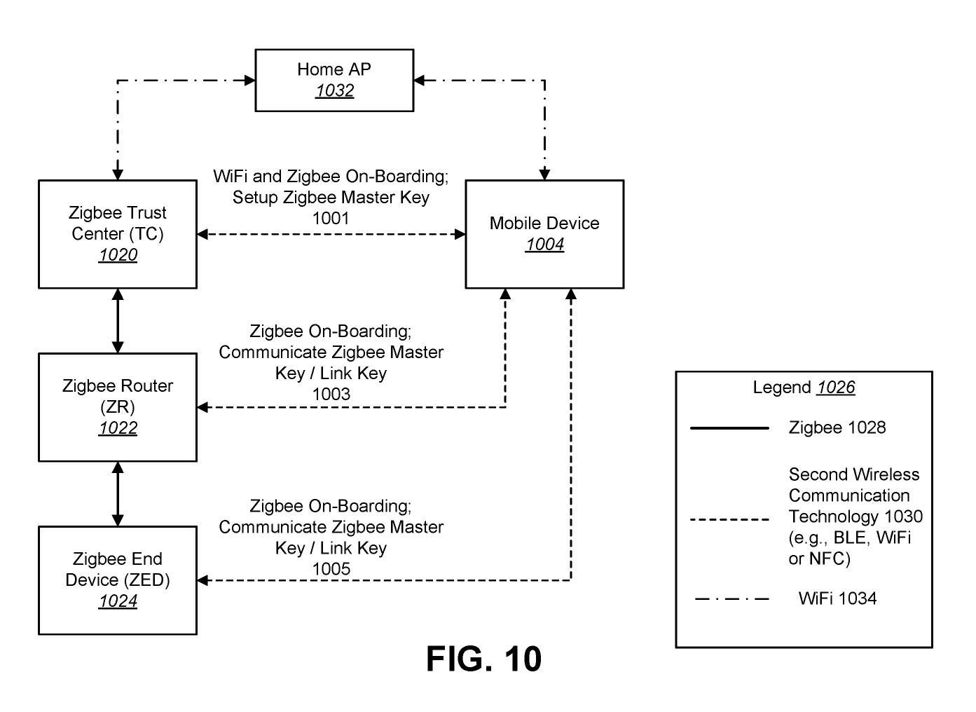

FIG. 10 is a block diagram illustrating a secure communication of Zigbee keys 116 in a Zigbee network. In particular, FIG. 10 illustrates Zigbee modified secure onboarding steps. In some configurations, the Zigbee network may include a home access point (AP) 1032. The home AP 1032 may be configured to communicate using WiFi. The Zigbee network may also include a Zigbee trust center (TC) 1020 that is configured to communicate via Zigbee protocols, a second wireless communication technology (e.g., BLE or NFC) and (optionally) WiFi. The Zigbee network may also include one or more Zigbee routers (ZR) 1022 and/or one or more Zigbee end devices (ZED) 1024. The TC 1020, ZR 1022 and ZED 1024 may be implemented in accordance with the Zigbee device 102 described in connection with FIG. 1. A legend 1026 indicates communications using Zigbee communication protocols 1028, communications using a second wireless communication technology 1030 (e.g., BLE, WiFi, NFC) and communications using WiFi communication protocols 1034.

A mobile device 1004 may establish a wireless link 1001 with the TC 1020 using the second wireless communication technology. For example, the mobile device 1004 may establish a BLE link (e.g., BLE v4.2 secure session or BLE v4.0/4.1) with the Zigbee TC 1020. The mobile device 1004 may be implemented in accordance with the mobile device 104 described in connection with FIG. 1.

The mobile device 1004 may onboard WiFi of the Zigbee TC 1020 to the home AP 1032. The mobile device 1004 may use the same wireless link 1001 on the second wireless communication technology to setup the Zigbee master key for the Zigbee TC' s role as “Zigbee coordinator/trust center.” The mobile device 1004 may also use the same wireless link 1001 on the second wireless communication technology to configure the Zigbee TC's role as Zigbee coordinator/Trust center.

The mobile device 1004 may establish a wireless link 1003 on the second wireless communication technology with a Zigbee router (ZR) 1022. The mobile device 1004 may perform Zigbee onboarding for the ZR 1022 using the wireless link 1003 on the second wireless communication technology. The mobile device 1004 may configure the Zigbee ZR 1022 to connect to the Zigbee TC 1020 in the role of a “Zigbee router.” The mobile device 1004 may communicate the Zigbee TC' s master key and/or a link key to the Zigbee ZR 1022 on the wireless link 1003. The mobile device 1004 may optionally communicate the Zigbee TC' s MAC address. In the case of BLE, the mobile device 1004 may also optionally connect the Zigbee ZR's BLE interface as a BLE peripheral to the Zigbee TC's BLE coordinator. This Zigbee ZR 1022 may be configured as “line-powered,” and by default it will start in the role of a ZR.

The mobile device 1004 may establish another wireless link 1005 on the second wireless communication technology with a Zigbee end-device (ZED) 1024. The mobile device 1004 may perform Zigbee onboarding for the ZED 1024 using the wireless link 1005 on the second wireless communication technology. The mobile device 1004 may communicate the Zigbee TC's master key and/or a link key to the ZED 1024. The mobile device 1004 may optionally communicate the Zigbee TC's MAC address. This Zigbee ZED 1024 may be configured as “battery-powered,” and by default it will start in the role of a ZED.

The mobile device 1004 may also optionally communicate to the ZED 1024 and/or ZR 1022 a list of MAC addresses about all of Zigbee ZRs 1022 and the Zigbee TC 1020 configured so far. This list will help a Zigbee ZED and/or Zigbee ZR 1022 to do a scan to connect to the strongest ZR 1022.

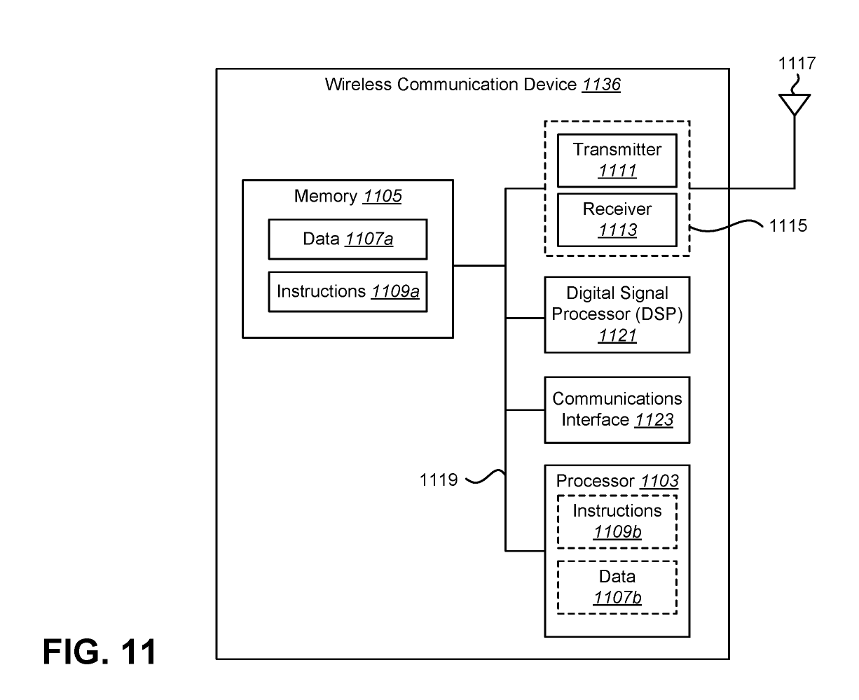

FIG. 11 illustrates certain components that may be included within a wireless communication device 1136. The wireless communication device 1136 described in connection with FIG. 11 may be an example of and/or may be implemented in accordance with a Zigbee device 102 (e.g., TC, ZR, ZED) and/or mobile device 104 described in connection with one or more of FIGS. 1-10.

The wireless communication device 1136 includes a processor 1103. The processor 1103 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1103 may be referred to as a central processing unit (CPU). Although just a single processor 1103 is shown in the wireless communication device 1136 of FIG. 11, in an alternative configuration, a combination of processors (e.g., an ARM and DSP) could be used.

The wireless communication device 1136 also includes memory 1105 in electronic communication with the processor (i.e., the processor can read information from and/or write information to the memory). The memory 1105 may be any electronic component capable of storing electronic information. The memory 1105 may be configured as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers and so forth, including combinations thereof.

Data 1107a and instructions 1109a may be stored in the memory 1105. The instructions may include one or more programs, routines, sub-routines, functions, procedures, code, etc. The instructions may include a single computer-readable statement or many computer-readable statements. The instructions 1109a may be executable by the processor 1103 to implement the methods disclosed herein. Executing the instructions 1109a may involve the use of the data 1107a that is stored in the memory 1105. When the processor 1103 executes the instructions 1109, various portions of the instructions 1109b may be loaded onto the processor 1103, and various pieces of data 1107b may be loaded onto the processor 1103.

The wireless communication device 1136 may also include a transmitter 1111 and a receiver 1113 to allow transmission and reception of signals to and from the wireless communication device 1136 via an antenna 1117. The transmitter 1111 and receiver 1113 may be collectively referred to as a transceiver 1115. The wireless communication device 1136 may also include (not shown) multiplier transmitters, multiplier antennas, multiplier receivers and/or multiplier transceivers.

The wireless communication device 1136 may include a digital signal processor (DSP) 1121. The wireless communication device 1136 may also include a communications interface 1123. The communications interface 1123 may allow a user to interact with the wireless communication device 1136.

The various components of the wireless communication device 1136 may be coupled together by one or more buses, which may include a power bus, a control signal bus, a status signal bus, a data bus, etc. For the sake of clarity, the various buses are illustrated in FIG. 11 as a bus system 1119.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C.

As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C.

As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method by a Zigbee device, comprising:
advertising that the Zigbee device is present using a second wireless communication technology;
establishing a wireless link with a mobile device using the second wireless communication technology; and
communicating a Zigbee key with the mobile device using the second wireless communication technology.

2. The method of claim 1, wherein communicating the Zigbee key with the mobile device comprises:
generating, by the Zigbee device, the Zigbee key in response to detecting the mobile device; and
sending the Zigbee key to the mobile device using the second wireless communication technology.

3. The method of claim 1, wherein communicating the Zigbee key with the mobile device comprises:
receiving the Zigbee key from the mobile device using the second wireless communication technology, wherein the mobile device generates the Zigbee key in response to detecting the Zigbee device.

4. The method of claim 1, wherein advertising that the Zigbee device is present using a second wireless communication technology comprises:
sending an advertising packet, using the second wireless communication technology, that indicates the Zigbee device is available to join a Zigbee network.

5. The method of claim 1, wherein the Zigbee device is a Zigbee Trust Center (TC), Zigbee router (ZR) or Zigbee end-device (ZED).

6. The method of claim 1, wherein the second wireless communication technology is Bluetooth Low Energy, WiFi or near-field communication (NFC).

7. The method of claim 1, wherein the Zigbee key includes a master key or link key used for communication in a Zigbee network.

8. A Zigbee device, comprising:
a processor;
a memory in electronic communication with the processor; and
instructions stored in the memory, the instructions executable by the processor to:
advertise that the Zigbee device is present using a second wireless communication technology;
establish a wireless link with a mobile device using the second wireless communication technology; and
communicate a Zigbee key with the mobile device using the second wireless communication technology.

9. The Zigbee device of claim 8, wherein the instructions executable to communicate the Zigbee key with the mobile device comprise instructions executable to:
generate, by the Zigbee device, the Zigbee key in response to detecting the mobile device; and
send the Zigbee key to the mobile device using the second wireless communication technology.

10. The Zigbee device of claim 8, wherein the instructions executable to communicate the Zigbee key with the mobile device comprise instructions executable to:
receive the Zigbee key from the mobile device using the second wireless communication technology, wherein the mobile device generates the Zigbee key in response to detecting the Zigbee device.

11. The Zigbee device of claim 8, wherein the instructions executable to advertise that the Zigbee device is present using a second wireless communication technology comprise the instructions executable to:
send an advertising packet, using the second wireless communication technology, that indicates the Zigbee device is available to join a Zigbee network.

12. The Zigbee device of claim 8, wherein the Zigbee device is a Zigbee Trust Center (TC), Zigbee router (ZR) or Zigbee end-device (ZED).

13. The Zigbee device of claim 8, wherein the second wireless communication technology is Bluetooth Low Energy, WiFi or near-field communication (NFC).

14. The Zigbee device of claim 8, wherein the Zigbee key includes a master key or link key used for communication in a Zigbee network.

15. A method by a mobile device, comprising:
detecting that a Zigbee device is present using a second wireless communication technology;
establishing a wireless link with the Zigbee device using the second wireless communication technology; and
communicating a Zigbee key with the Zigbee device using the second wireless communication technology.

16. The method of claim 15, wherein communicating the Zigbee key with the Zigbee device comprises:
generating, by the mobile device, the Zigbee key in response to detecting the Zigbee device; and
sending the Zigbee key to the Zigbee device using the second wireless communication technology.

17. The method of claim 15, wherein communicating the Zigbee key with the Zigbee device comprises:
receiving the Zigbee key from the Zigbee device using the second wireless communication technology, wherein the Zigbee device generates the Zigbee key in response to detecting the mobile device.

18. The method of claim 15, wherein detecting that the Zigbee device is present using a second wireless communication technology comprises:
detecting an advertising packet, using the second wireless communication technology, that indicates the Zigbee device is available to join a Zigbee network.

19. The method of claim 15, further comprising:
saving the Zigbee key in a Zigbee key database; and
communicating the Zigbee key with a second Zigbee device using the second wireless communication technology.

20. The method of claim 15, wherein the Zigbee device is a Zigbee Trust Center (TC), Zigbee router (ZR) or Zigbee end-device (ZED).

21. The method of claim 15, wherein the second wireless communication technology is Bluetooth Low Energy, WiFi or near-field communication (NFC).

22. The method of claim 15, wherein the Zigbee key includes a master key or link key used for communication in a Zigbee network.

23. A mobile device, comprising:
a processor;
a memory in electronic communication with the processor; and
instructions stored in the memory, the instructions executable by the processor to:
detect that a Zigbee device is present using a second wireless communication technology;
establish a wireless link with the Zigbee device using the second wireless communication technology; and
communicate a Zigbee key with the Zigbee device using the second wireless communication technology.

24. The mobile device of claim 23, wherein the instructions executable to communicate the Zigbee key with the Zigbee device comprise instructions executable to:
generate, by the mobile device, the Zigbee key in response to detecting the Zigbee device; and
send the Zigbee key to the Zigbee device using the second wireless communication technology.

25. The mobile device of claim 23, wherein the instructions executable to communicate the Zigbee key with the Zigbee device comprise instructions executable to:
receive the Zigbee key from the Zigbee device using the second wireless communication technology, wherein the Zigbee device generates the Zigbee key in response to detecting the mobile device.

26. The mobile device of claim 23, wherein the instructions executable to detect that the Zigbee device is present using a second wireless communication technology comprise instructions executable to:
detect an advertising packet, using the second wireless communication technology, that indicates the Zigbee device is available to join a Zigbee network.

27. The mobile device of claim 23, further comprising instructions executable to:
save the Zigbee key in a Zigbee key database; and
communicate the Zigbee key with a second Zigbee device using the second wireless communication technology.

28. The mobile device of claim 23, wherein the Zigbee device is a Zigbee Trust Center (TC), Zigbee router (ZR) or Zigbee end-device (ZED).

29. The mobile device of claim 23, wherein the second wireless communication technology is Bluetooth Low Energy, WiFi or near-field communication (NFC).

30. The mobile device of claim 23, wherein the Zigbee key includes a master key or link key used for communication in a Zigbee network.
